(19) United States
(12) Patent Application Publication
(10) Pub. No.: US 2026/0087600 A1
(43) Pub. Date: Mar. 26, 2026

(54) PER-ASSET DENOISING FOR REAL-TIME RENDERING OF NEURAL RADIANCE FIELDS (NERFS)

(71) Applicants: Adobe Inc., San Jose, CA (US); THE REGENTS OF THE UNIVERSITY OF CALIFORNIA, Oakland, CA (US)

(72) Inventors: Sai Bi, San Jose, CA (US); Zexiang Xu, San Jose, CA (US); Xin Sun, Palo Alto, CA (US); Miloš Hašan, Lafayette, CA (US); Kunal Gupta, Pittsburgh, PA (US); Kevin Blackburn-Matzen, Seattle, WA (US); Kalyan Krishna Sunkavalli, San Jose, CA (US); Kai Zhang, San Jose, CA (US); Julien Olivier Victor Philip, Greater London (GB); Fujun Luan, Sunnyvale, CA (US); Manmohan Chandraker, San Jose, CA (US); Iliyan Atanasov Georgiev, London (GB)

(73) Assignees: Adobe Inc., San Jose, CA (US); THE REGENTS OF THE UNIVERSITY OF CALIFORNIA, Oakland, CA (US)

(21) Appl. No.: 18/894,541

(22) Filed: Sep. 24, 2024

(51) Int. Cl. G06T 5/70; G06T 5/20; G06T 17/00

(52) U.S. Cl. CPC G06T 5/70; G06T 5/20; G06T 17/00; G06T 2207/20081; G06T 2207/20084

(57) ABSTRACT

In implementing per-asset denoising for real-time rendering of neural radiance fields (NeRFs), a processing device receives a three-dimensional (3D) representation of a scene as a NeRF. The processing device generates an intermediate rendering of the scene using the NeRF. The intermediate rendering is denoised using a machine-learning model to generate a final rendering. The machine-learning model is trained on another rendering of this scene, which was rendered using a non-real-time, high-quality rendering scheme. In other words, the machine-learning model is optimized for each scene and provides a lightweight denoising network to provide real-time NeRF rendering while maintaining the high-quality visuals of non-real-time rendering schemes. The final rendering is then presented via a display device.

### BACKGROUND

A digital three-dimensional (3D) model is a computer-generated representation of a 3D scene or object that captures a scene or object's shapes, sizes, and appearance (e.g., color, texture). One conventional technique for 3D modeling involves using neural radiance fields (NeRFs) to create detailed models of complex 3D scenes, often based on two-dimensional (2D) images. NeRFs represent a scene as a continuous 3D function and use a volume rendering integral to calculate radiance along a ray. In this way, NeRFs fit a set of photos (e.g., 2D images) to the 3D function and create different views with high visual quality. NeRF models are used in various industries, including computer graphics, virtual and augmented reality, robotics, architecture, product design, and engineering. However, rendering NeRF models in real-time uses significant computational power that exceeds the capabilities of typical consumer electronic devices.

### SUMMARY

Techniques and systems for per-asset denoising for real-time rendering of NeRFs are described. In one example, a processing device receives or generates a NeRF representation of an object (e.g., a stuffed animal). The processing device uses Monte Carlo sampling of the NeRF to generate a first rendering of the stuffed animal quickly. A machine-learning model generates a second rendering to remove noise introduced by the Monte Carlo sampling. The processing device previously optimized the machine-learning model to denoise renderings of the stuffed animal using a non-real-time, high-quality rendering of the stuffed animal. The second rendering of the stuffed animal is then presented to the user in real-time.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRA WINGS

The detailed description is described with reference to the accompanying figures. Entities represented in the figures are indicative of one or more entities and thus reference is made interchangeably to single or plural forms of the entities in the discussion.

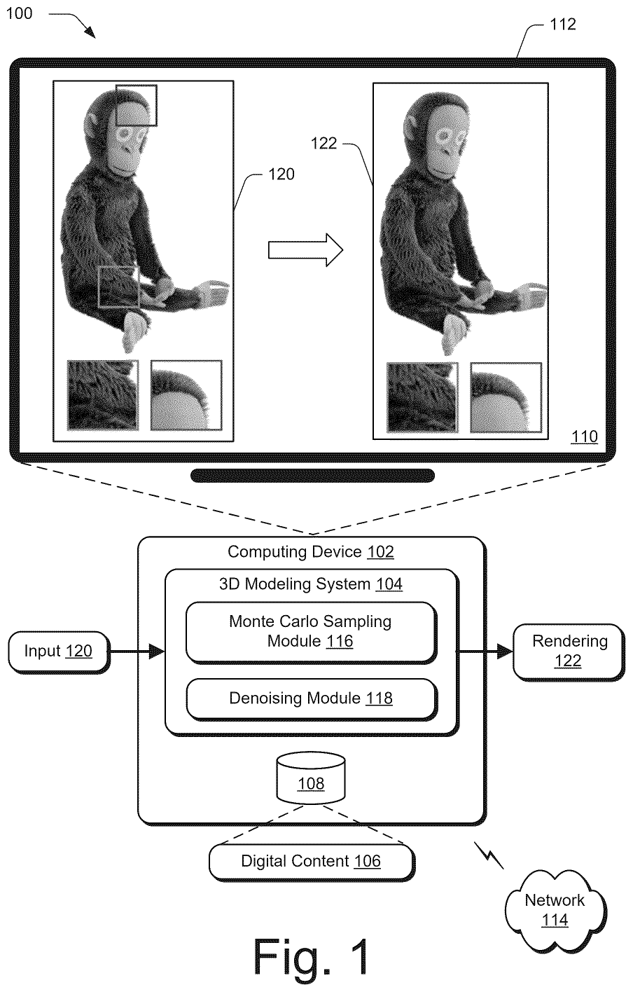

FIG. 1 is an illustration of a digital medium environment in an example implementation that is operable to employ techniques and systems for per-asset denoising for real-time rendering of NeRFs as described herein.

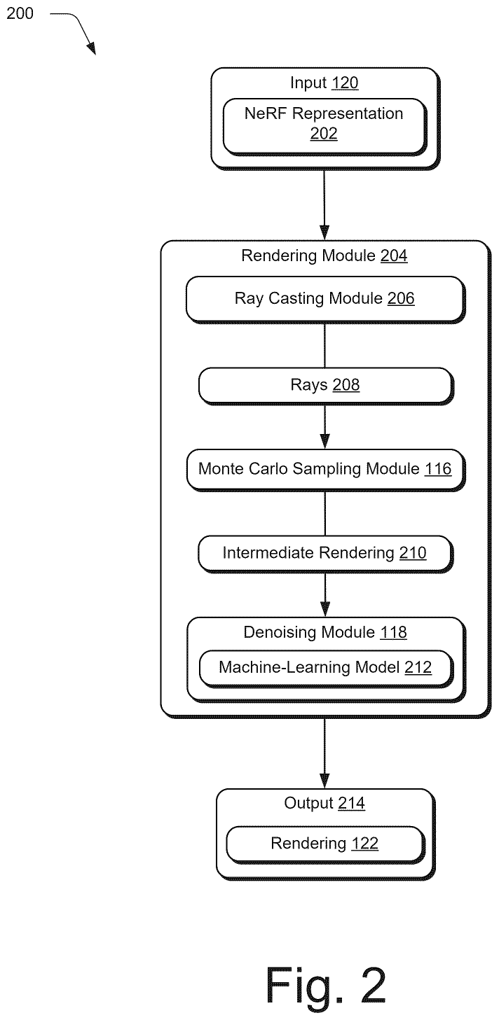

FIG. 2 depicts a system in an example implementation showing an operation of a per-asset denoising network for real-time rendering of NeRFs.

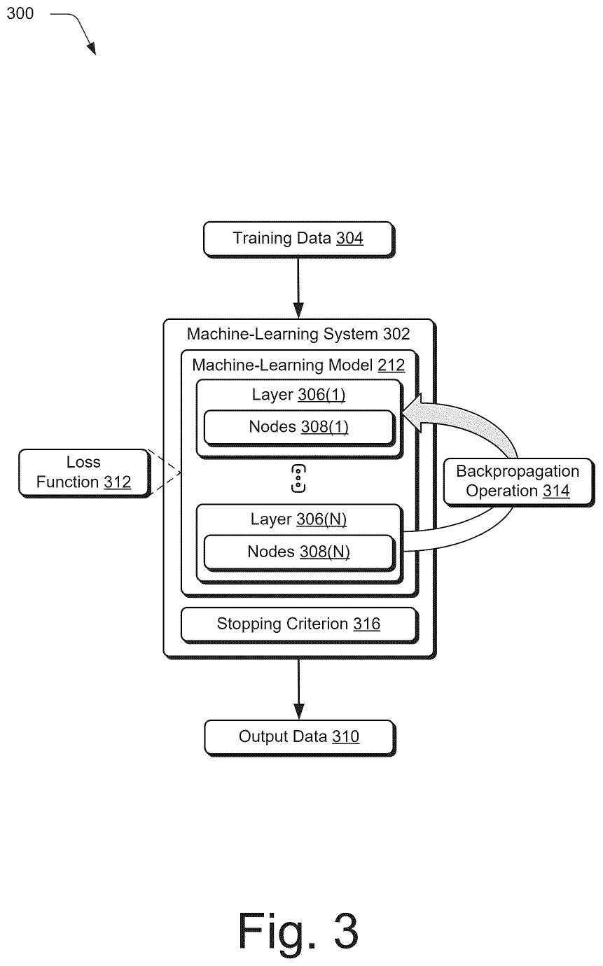

FIG. 3 depicts a system and procedure in an example implementation for training a machine-learning model.

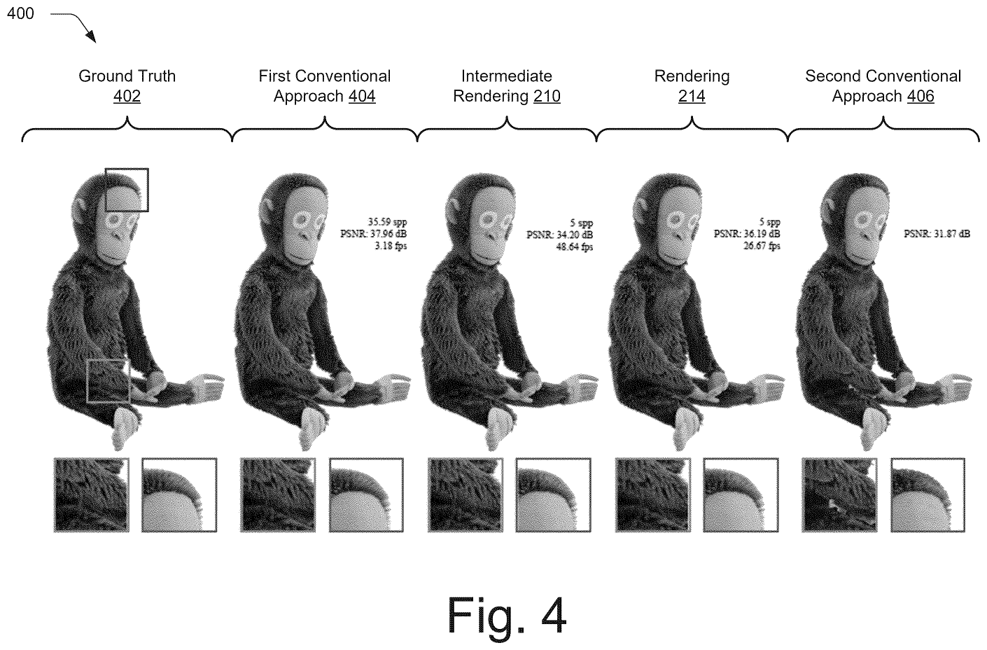

FIG. 4 depicts an example of a rendered object generated using the described per-asset denoising for real-time rendering versus conventional NeRF rendering techniques.

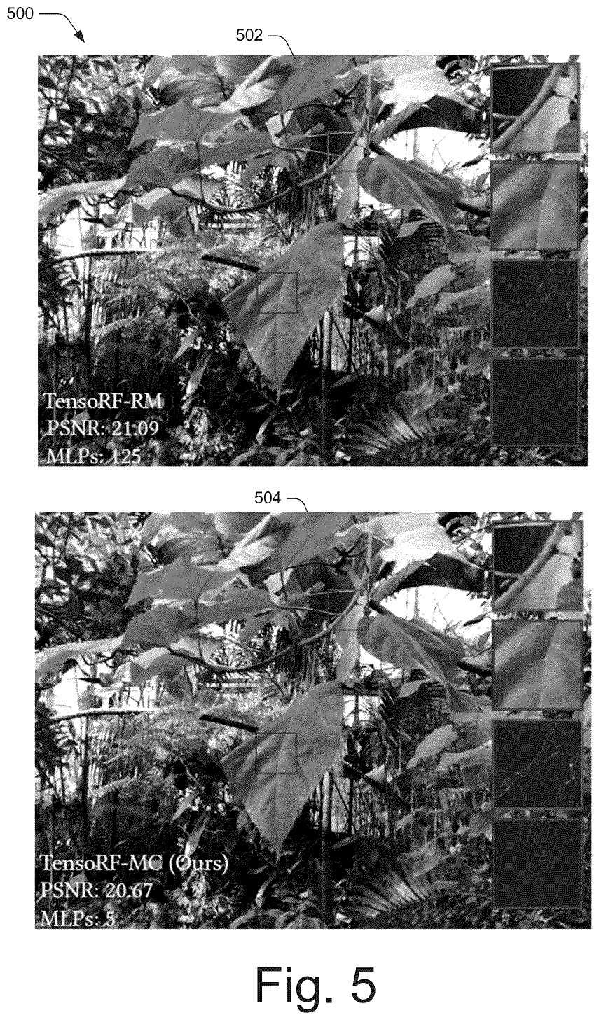

FIG. 5 depicts an example of another rendered object generated using the described per-asset denoising for real-time rendering versus a conventional NeRF rendering technique.

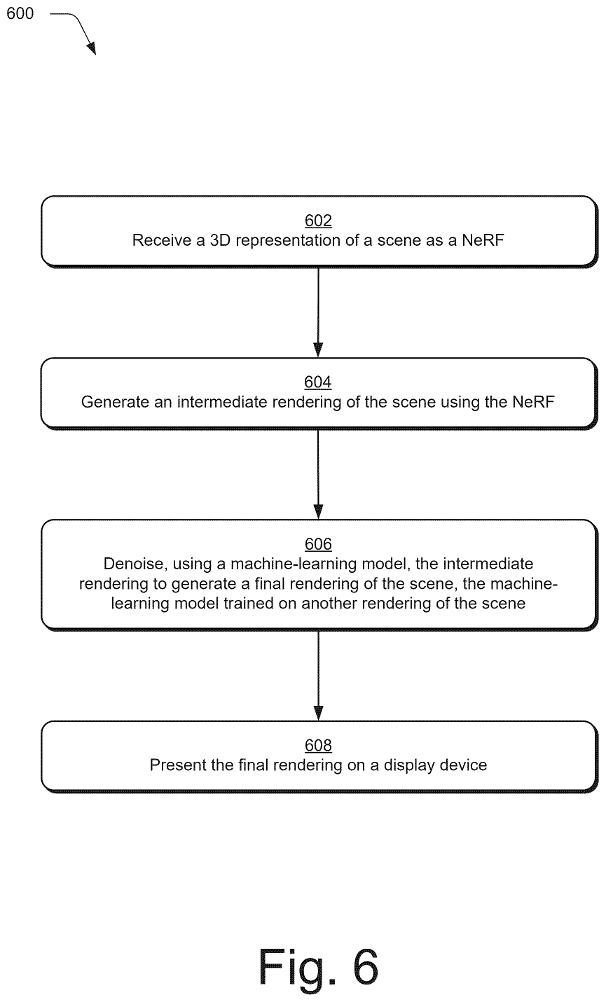

FIG. 6 depicts a procedure in an example implementation of per-asset denoising for real-time rendering of NeRFs.

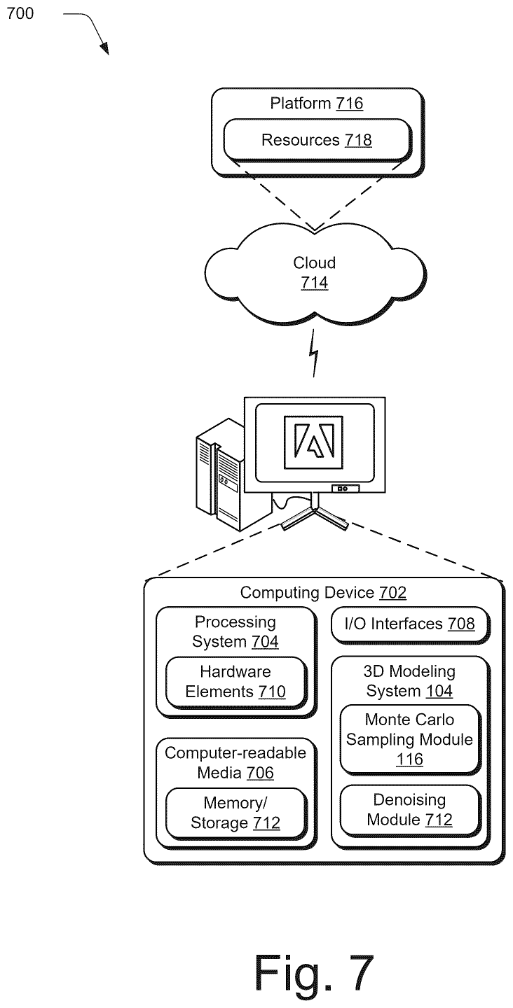

FIG. 7 illustrates an example system including various components of an example device that can be implemented as any type of computing device as described and/or utilized with reference to FIGS. 1-6 to implement embodiments of the techniques described herein.

### DETAILED DESCRIPTION

### Overview

NeRFs and their variations can produce high-quality renderings and views of complex 3D scenes. NeRF represents a scene as a continuous 3D function to which a set of photos or 2D images is set. A volume rendering integral via ray marching is then applied to accumulate the radiance of densely sampled points along the ray. This rendering process enables the synthesizing of novel views with high visual quality. However, the rendering process is computationally expensive and time-consuming.

For each pixel, the rendering process involves marching along a camera ray by sampling a dense set of points and evaluating their radiance contributions, often using computationally expensive operations such as multi-layer perceptron (MLP) evaluations. Some techniques reduce the computational expense by using smaller MLPs or approximating the MLP evaluations, but these approaches introduce noise and reduce the visual quality of the scene renderings. To overcome these issues, a sampling scheme is described that accelerates NeRF rendering in combination with per-asset denoising to maintain the visual quality of conventional techniques.

Some conventional techniques speed up NeRF rendering by using different scene representations (e.g., mesh-based representations) that are faster to render. Such mesh-based representations cannot reproduce the original high visual quality of volumetric NeRF models, especially for intricate geometries (e.g., fur). In addition, these different scene representations often utilize complex multi-stage pipelines that are time-consuming to optimize.

While the original NeRF model uses a large MLP to model the global scene, other conventional techniques use spatial features and smaller MLPs to reduce computational expense. These techniques improve reconstruction speed but still fail to achieve real-time renderings. Another conventional technique reduces evaluations using discretized voxel feature grids; however, while achieving real-time rendering, these techniques incur large storage and processing memory costs.

Accordingly, a lightweight framework for real-time NeRF rendering is described that supports denoising on a per-asset basis. Instead of creating different representations or overhauling the volume rendering procedure, the described system minimizes the number of samples utilized for accurately computing the NeRF volume rendering integral through Monte Carlo importance sampling and per-asset denoising.

The described rendering scheme utilizes Monte Carlo integration over the samples on each ray to approximate the NeRF volume rendering integral. Monte Carlo sampling reduces the computational rendering expense by sampling a sparse set of points along each ray to estimate the pixel's color. The quality of the approximation depends on the number of samples used (with full raymarching as an upper bound) and the sampling strategy. Because of the ray density distribution, the described system utilizes an importance sampling scheme to evaluate samples that contribute most to the pixel radiance. A dense evaluation of per-point density is used to compute this distribution, which is sped up by using factorized tensors or discretized density grids. Pixel radiance is computed by evaluating per-point radiance at a fraction of the samples compared to conventional rendering techniques, leading to significant rendering speedups (e.g., up to a factor of seven) by simple modifications to the sampling scheme without changing the scene representation.

However, Monte Carlo importance sampling introduces noise in the final renderings, which impacts the final image quality. The described techniques address the noise issue by combining the Monte Carlo rendering with an image-space denoising network trained on the particular scene to be rendered.

Conventional denoising networks focus on training a general neural network across multiple scenes. These conventional denoising networks are typically large, time-consuming to train, and cannot run in real-time on standard consumer hardware. In contrast, this document describes a lightweight denoising network (e.g., with as few as two convolutional layers) specifically trained or optimized for each scene, enabling fast training and real-time rendering. Using the described techniques and systems, rendering quality comparable to conventional naïve NeRF volume renderings is achievable with as few as one to five samples per pixel, which significantly improves rendering speed with marginal quality loss. Adopting a lightweight denoising network simplifies optimization and uses substantially less reconstruction time than conventional NeRF rendering techniques. The described Monte Carlo rendering and denoising techniques are also generally agnostic to the neural scene representation used.

In one implementation, an intermediate rendering of a scene is generated from a NeRF. The intermediate rendering is denoised using a machine-learning model to generate a final rendering. The machine-learning model is trained on another rendering of this scene, which was rendered using a non-real-time, high-quality rendering scheme. The final rendering is then presented via a display device. In this way, the machine-learning model optimized for the scene to be rendered provides a lightweight denoising network to provide real-time NeRF rendering while maintaining the high-quality visuals of non-real-time rendering schemes.

The following discussion describes an example environment that employs the techniques described herein. Example procedures that are performable in the example environment and other environments are also described. Consequently, the performance of the example procedures is not limited to the example environment, and the example environment is not limited to the performance of the example procedures.

### Example Environment

FIG. 1 is an illustration of a digital medium environment 100 in an example implementation that is operable to employ techniques and systems for per-asset denoising for real-time rendering of NeRFs as described herein. The illustrated digital medium environment 100 includes a computing device 102, which is configurable in various ways.

The computing device 102, for instance, is configurable as a desktop computer, a laptop computer, a mobile device (e.g., assuming a handheld configuration such as a tablet or mobile phone), an augmented reality device, and so forth. Thus, computing device 102 ranges from full-resource devices with substantial memory and processor resources (e.g., personal computers and game consoles) to a low-resource device with limited memory and/or processing resources (e.g., mobile devices). Additionally, although a single computing device 102 is shown, the computing device 102 is also representative of a plurality of different devices, such as multiple servers a business utilizes to perform operations “over the cloud” as described in FIG. 7.

The computing device 102 also includes a 3D modeling system 104 as part of an image processing system. The 3D modeling system 104, along with the image processing system, is implemented at least partially in the hardware of the computing device 102 to process and represent digital content 106, illustrated as maintained in storage 108 of the computing device 102. Such processing includes creating the digital content 106, representing the digital content 106, modifying the digital content 106, and rendering the digital content 106 for display in a user interface 110 for output, e.g., by a display device 112. Although illustrated as implemented locally at the computing device 102, functionality of the 3D modeling system 104 is also configurable entirely or partially via functionality available via the network 114, such as part of a web service or “in the cloud.”

The computing device 102 also includes a Monte Carlo sampling module 116 and a denoising module 118, illustrated as incorporated by the 3D modeling system 104 to process the digital content 106. In some examples, the Monte Carlo sampling module 116 and the denoising module 118 are separate from the 3D modeling system 104 such as in an example in which the rendering and/or denoising features of the Monte Carlo sampling module 116 and the denoising module 118, respectively, are available via the network 114.

NeRFs are generally rendered using volume rendering techniques and ray tracking. Rays are cast from a camera through each pixel of a scene. The rays intersect the 3D space represented by the NeRF. Multiple points are sampled along each ray to obtain the color and density, which vary continuously within the 3D space of the NeRF scene representation. The color and density values are then combined using volume rendering by integrating the color and density along the ray to produce the final color for each pixel. Although such conventional rendering techniques produce photorealistic results, these techniques are inherently slow because they evaluate an MLP for many sample points for each ray.

Some conventional techniques improve the rendering speed with neural scene representations that are faster to evaluate or by pre-computing (and approximating) scene properties. In contrast, the Monte Carlo sampling module 116 uses a Monte Carlo-based rendering algorithm to speed up rendering without altering the NeRF representation of an input 120. Monte Carlo sampling involves randomly sampling a probability distribution to solve deterministic problems. An importance-sampling variation improves Monte Carlo simulations by focusing sampling efforts on regions of the input space that contribute most significantly to the final result. Accordingly, the Monte Carlo sampling module 116 efficiently computes the NeRF volume rendering integral using an importance sampling scheme based on ray density distributions. In this way, a small number of MLP evaluations are used by the Monte Carlo sampling module 116 to estimate pixel radiance.

The intermediate rendering output by the Monte Carlo sampling module 116 is then denoised using the denoising module 118, an image-space denoiser trained on individual scenes (e.g., input 120). The denoising module 118 is trained and applied as a lightweight scene-specific denoiser to output high-quality rendering 122 in real time as described in greater detail with respect to FIG. 2.

The Monte Carlo sampling module 116 speeds up NeRF rendering by up to seven times, and the denoising module 118 provides final renderings 122 that closely match the visual quality of conventional techniques without making the scene approximations that other real-time conventional techniques usually make. The combination of the Monte Carlo sampling module 116 and denoising module 118 provides high-quality, real-time NeRF rendering that applies to various NeRF representations, assuming the representations express a radiance field and render images with a differentiable volume rendering equation (as discussed in greater detail with respect to FIG. 2).

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Per-Asset Denoising

FIG. 2 depicts a system 200 in an example implementation showing an operation of a denoising module of FIG. 1 in greater detail for per-asset denoising of real-time rendering of NeRFs. The following discussion describes implementable techniques utilizing the previously described systems and devices. Aspects of each procedure are implemented in hardware, firmware, software, or a combination thereof. The procedures are shown as a set of blocks that specify operations performed and/or caused by one or more devices and are not necessarily limited to the orders shown for performing the operations by the respective blocks.

The system 200 includes a rendering module 204 that receives input 120, which includes a NeRF representation 202 of a 3D scene or object. The rendering module 204 uses a ray casting module 206, the Monte Carlo sampling module 116, and the denoising module 118 to generate high-quality, real-time renderings 122 as an output 214.

NeRF representations 202 encode a 3D scene as a continuous radiance field function ƒ: (x,d)→(c,σ) which takes as input the 3D position x=(x,y,z) and viewing direction d=(θ,φ) and predicts the radiance c=(r,g,b) and volume density σ. The color depends on the viewing direction d and position x to capture view-dependent effects, while the density depends on just the position x to maintain view consistency. NeRF uses MLPs to model the radiance field f and an emission-only volumetric rendering model for radiance computation.

The ray casting module 206 casts rays 208 from a camera through each pixel of the desired image. The rays 208 intersect the 3D space of the NeRF representation 202. The color Ĉ(r) along a camera ray r(t)=o+td beginning at camera center o in the direction d is computed by approximating the volumetric rendering integral via quadrature:

$$\hat{C} ( r ) = {\sum }_{i = 1}^{N} {T}_{i} \cdot {α}_{i} \cdot {c}_{i} , \qquad ( 1 )$$

$${T}_{i} = {\prod }_{j = 1}^{i - 1} ( 1 - {α}_{j} ) , {α}_{i} = 1 - exp ( - {σ}_{i} {δ}_{i} ) ,$$

where αᵢ is known as the opacity and indicates the probability that the ray 208 terminates at the point i and δᵢ=tᵢ₊₁−tᵢ denotes the distance between neighboring points along the ray. The accumulated transmittance Tᵢ represents the probability that a ray travels up to i without hitting a particle. Given a training set of posed images, NeRF is optimized to minimize the mean-squared error (MSE) between per-pixel predicted renderings Ĉ(rₚ) and the corresponding ground-truth color C(rₚ) for all pixels p in the set of training pixels [symbol] :

$${ℒ}_{MSE} = {‖ \hat{C} ( {r}_{p} ) - C ( {r}_{p} ) ‖}_{2}^{2} . \qquad ( 2 )$$

Using a single MLP in NeRF leads to a compact scene representation, but the rendering is computationally expensive to evaluate. Because computing Equation (1) accurately often involves hundreds of samples per ray, such representations become intractable for real-time rendering. Even if smaller but multiple MLPs are used, the cost associated with hundreds of MLP evaluations per pixel is still significant.

The original ray marching sum in Equation (1) used for rendering images with NeRF is rewritable as a weighted sum of radiances of each sample along the ray:

$$\hat{C} ( r ) = {\sum }_{i = 1}^{N} {T}_{i} \cdot {α}_{i} \cdot {c}_{i} = {\sum }_{i = 1}^{N} {w}_{i} \cdot {c}_{i} \qquad ( 3 )$$

where wᵢ=Tᵢ·αᵢ and refers to the weight of the i-th sample along the ray segment bounded by near and far planes.

The sum of the weights,

$$W = {\sum }_{i = 1}^{N} {w}_{i} ,$$

is the opacity of the ray (e.g., one minus its transmittance). The weights define a probability distribution over the samples: pᵢ=wᵢ/W. Randomly choosing a sample i from this distribution and returning cᵢW is an unbiased estimator of the desired radiance Ĉ(rₚ) because the expected value of the estimator is:

$${\sum }_{i = 1}^{N} {p}_{i} {c}_{i} W = {\sum }_{i = 1}^{N} {w}_{i} {c}_{i} = \hat{C} ( r ) \qquad ( 4 )$$

This Monte Carlo estimator is efficient because only a few weights along the ray (e.g., the ones close to a surface) typically have high values. In addition, the radiance frequently does not vary much among these high-weight samples.

The sampling is implemented without storing the probabilities explicitly in an array by using two passes over each ray. In the first pass, the Monte Carlo sampling module 116 computes the opacity W, which can also be used for background compositing with no noise. In the second pass, the Monte Carlo sampling module 116 selects a random number in [0,W] and uses it to sample i based on the cumulative distribution of the weights.

In at least one implementation, the Monte Carlo sampling module 116 extends the two-pass scheme to M>1 samples along the same ray. To do so, the Monte Carlo sampling module 116 selects multiple random numbers in [0,W] (e.g., by stratifying the interval) and selects multiple indices in the second pass. If some indices coincide, each is counted separately, but the Monte Carlo sampling module 116 evaluates the radiance once. As a result, M samples often take less than M times one sample's cost.

Computing the sampling distribution still involves evaluating the weights at a dense set of samples. However, when the density-to-weight evaluation is much cheaper than radiance, M<<N ensures fast volume rendering due to fewer samples and, thus, fewer color MLPs being evaluated. With as few as one to five samples, the Monte Carlo sampling module 116 accurately estimates the volume rendering integral.

The described Monte Carlo sampling module 116 is compatible with many volumetric NeRF models to accelerate its rendering as long as the weights are computationally cheap compared to color evaluation. Such cheap computation is achieved by modeling the volume density with factorized tensors or discrete voxel grids. The Monte Carlo sampling module 116 applies importance sampling to the discrete ray marching sum, rather than the original continuous volume rendering integral because the optimization of the original NeRF representation was based on discrete ray marching. Additional details of the Monte Carlo sampling module 116 are introduced and described in U.S. application Ser. No. 18/499,673, filed on Nov. 1, 2023, the entirety of which is incorporated by reference herein. However, the Monte Carlo sampling module 116, especially with the importance sampling of the volume rendering integral, introduces noise in the intermediate renderings 210 due to the variance caused by low sample counts.

To address the noise in the intermediate renderings 210, the rendering module 204 uses the denoising module 118 to remove the noise and maintain high-quality visuals. The denoising module 118 includes a machine-learning model 212, an optimized lightweight image-space denoiser capable of denoising Monte Carlo rendering in real-time. The machine-learning model 212 operates directly on the path-traced samples to summarize rich per-sample information into low-dimensional per-pixel feature vectors.

The machine-learning model 212 takes as input the noisy red-green-blue (RGB) image Ĩ and alpha channel \tilde{Λ} of the intermediate rendering 210 and outputs a set of affinity features f_{x y}∈ [symbol] ^{d}, and bandwidth scalars a_{x y}<0 and q_{x y}∈[0,1]:

$$( {f}_{xy} , {a}_{xy} , {q}_{xy} ) = Denoiser ( \tilde{I} , \tilde{Λ} ) . \qquad ( 5 )$$

The machine-learning model 212 uses these bandwidth scalars and affinity features to compute spatial kernels K, which are subsequently applied to the noisy input image I (e.g., the intermediate rendering 210) to get a denoised image Î=κ⊙Ĩ (e.g., the rendering 122 as an output 214). Here the operator ⊙ refers to a convolution operation. Specifically, the machine-learning model 212 computes the spatial kernals by calculating distances between affinity features f_{x y}, scaled by the bandwidth scalars a_{x y} with c_{x y} as the kernel's central weight. The spatial filtering kernels are computed as follows:

$${κ}_{xyuv} = \{ \begin{matrix}{q}_{xy} & if x = u and y = v , \\ exp ( - {a}_{xy} {‖ {f}_{xy} - {f}_{uv} ‖}_{2}^{2} ) & otherwise .\end{matrix} \qquad ( 6 )$$

The spatial kernels allow the machine-learning model 212 to learn to attend to neighboring pixels and pool the intensity based on the affinity of the local affinity feature value f_{u v} to the central-pixel affinity feature value f_{x y}. In this way, the denoised pixel lies within the convex hull of the kernel pixels and does not exhibit color shifts.

In one implementation, the machine-learning model 212 uses three convolutional layers with three-by-three kernels and rectified linear unit (ReLU) activations, each convolution layer having eight output channels. The machine-learning model 212 uses a spatial kernel size of five. In other implementations, the number of convolutional layers is less than ten to maintain a lightweight, computationally cheap denoising process. Because the decoder of the Monte Carlo sampling module 116 captures the local context of each pixel, the denoising module 118 utilizes a small network size for the machine-learning model 212. This relatively small size introduces a minimal computational overhead, allowing for real-time view synthesis. The machine-learning model 212 also does not introduce noticeable inconsistency across frames because the network is shallow.

FIG. 3 depicts a system and procedure in an example implementation 300 for training a machine-learning model 212 of the denoising module 118 of FIGS. 1 and 2 as part of a machine-learning system 302. The machine-learning model 212 is illustrated as implemented as part of the machine-learning system 302. The machine-learning system 302 is representative of functionality to generate training data 304, use the generated training data 304 to train the machine-learning model 212, and/or use the trained machine-learning model 212 as implementing the functionality described herein.

A machine-learning model 212 refers to a tunable computer representation (e.g., through training and retraining) based on inputs without being actively programmed by a user to approximate unknown functions, automatically and without user intervention. In particular, the term machine-learning model includes a model that utilizes algorithms to learn from and make predictions on known data by analyzing training data to learn and relearn to generate outputs (e.g., renderings 122) that reflect patterns and attributes of the training data or remove noise from intermediate renderings 210. Examples of machine-learning models include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc. As described above, the machine-learning model 212 uses a convolutional neural network to denoise the intermediate renderings 210 based on training data 304.

In the illustrated example, the machine-learning model 212 is configured using a plurality of layers 306(1), . . . , 306(N) having, respectively, a plurality of nodes 308(1), . . . , 308(N). The plurality of layers 306(1)-306(N) are configurable to include an input layer, an output layer, and one or more hidden layers. Calculations are performed by the nodes 308(1)-308(N) within the layers via hidden states through a system of weighted connections that are “learned” during training to implement a variety of tasks (e.g., caption generation). As described above, one implementation of the machine-learning model 212 includes a denoiser network with three convolutional layers with three-by-three kerns and ReLU activations, each convolutional layer having eight output channels.

In order to train the machine-learning model 212, training data 304 is received that provides examples of “what is to be learned” by the machine-learning model 212, i.e., as a basis to learn patterns from the data. The machine-learning system 302, for instance, collects and preprocesses the training data 304 that includes input features and corresponding target labels, i.e., of what is exhibited by the input features as obtained from a rendered view of the NeRF representation 202 using a conventional, non-real-time rendering technique with high-quality visuals. The machine-learning system 302 then initializes the parameters of the machine-learning model 212, which the machine-learning system 302 uses as internal variables to represent and process information during training and represent interferences gained through training on that individual scene. In this way, the machine-learning model 212 is trained on a per-scene or per-asset basis specific to the input 120.

The training data 304 is then received as input and used to generate predictions based on the current state of parameters of layers 306(1)-306(N) and corresponding nodes 308(1)-308(N) of the model. After a NeRF representation is optimized, Monte Carlo rendering of training set frames is performed to obtain a paired set {Ĩ, \tilde{Λ}, I} of noisy RGB images and alpha-channel inputs corresponding to the clean ground truth images I of the specific scene to be rendered and denoised (e.g., rendered using a conventional rendering technique that provides high-quality visuals but not in real-time). The machine-learning model 212 outputs its result as output data 310. Output data 310 describes an outcome of the task (e.g., denoising the intermediate rendering 210).

Training the machine-learning model 212 includes calculating a loss function 312 to quantify a loss associated with operations performed by nodes 308 of the machine-learning model 212. Calculating the loss function 312, for instance, includes comparing a difference between predictions specified in the output data 310 with target labels specified by the training data 304. The loss function 312 is configurable in various ways, including regression, the quadratic loss function as part of a least squares technique, and so forth.

Calculating the loss function 312 also includes using a backpropagation operation 314 to minimize the loss function 312, thereby training the parameters of the machine-learning model 212. Minimizing the loss function 312 includes adjusting the weights of the nodes 308(1)-308(N) to minimize the loss and thereby optimize the performance of the machine-learning model 212 for a particular task. The adjustment is determined by computing a gradient of the loss function 312, which indicates a direction to be used to adjust the parameters for minimizing the loss. The parameters of the machine-learning model 212 are then updated based on the computed gradient. In one implementation, the machine-learning model 212 is trained via gradient descent to minimize reconstruction loss and structure preserving loss to boost visual quality:

$${ℒ}_{denoiser} = {ℒ}_{recon} + {λℒ}_{SSIM}$$

$${ℒ}_{recon} = {‖ \hat{I} - \tilde{I} ‖}_{2}^{2}$$

$${ℒ}_{SSIM} = 1 - SSIM ( \hat{I} , \tilde{I} )$$

This process continues over several iterations until a stopping criterion 316 is met. In this example, the stopping criterion 316 is employed by the machine-learning system 302 to reduce overfitting of the machine-learning model 212 and reduce computational resource consumption. Examples of a stopping criterion 316 include but are not limited to a predefined number of epochs, validation loss stabilization, achievement of a performance improvement threshold, or based on performance metrics such as precision and recall. In this way, the machine-learning model 212 is optimized on a per-scene or per-asset basis to provide high-quality visuals for real-time rendering using a lightweight neural network.

### Example NeRF Renderings

FIG. 4 depicts examples 400 of rendered objects generated using conventional NeRF rendering techniques versus the described Monte Carlo sampling and per-asset denoising techniques described herein. The original object is a furry stuffed monkey doll that exhibits a complex fuzzy appearance with thin structures and fiber curves (as illustrated in the cutouts), with a ground truth 402 of the NeRF representation provided at the left end of FIG. 4.

In the first example, the monkey is rendered using a first conventional approach 404. In particular, the monkey is rendered using a conventional technique that replaces a large MLP with smaller MLPs and uses spatial features to reduce the computations. The first conventional approach 404 accurately reconstructs the volumetric appearance of the monkey with a peak signal-to-noise ratio (PSNR) of 37.96 dB. The PSNR measures the visual quality of the first rendered object 502 compared to the ground truth (e.g., the original NeRF representation of the jungle scene). The higher the PSNR score the better the visual quality of the NeRF rendering. However, the first conventional approach 404 involves a large number of raymarching sample evaluations (e.g., an average of 35.59 samples per pixel (spp)) and runs only at 3.18 frames per second (fps).

By incorporating the Monte Carlo sampling module 116, the intermediate rendering 210 reduces the number of evaluations (e.g., 5 spp), allowing the rendering module 204 to render in real-time (e.g., running at 48.64 fps). As illustrated in the cutouts of FIG. 4, the visual quality is reduced to a PSNR of 34.20 dB due to the noise introduced by the Monte Carlo importance sampling.

By combining the Monte Carlo sampling module 116 with the denoising module 118, rendering 122 approaches the visual quality of the first conventional approach 404 while maintaining real-time rendering. In particular, rendering 122 has a PSNR of 36.19 dB with only 5 spp and a rendering speed of 26.67 fps. In contrast, a second conventional approach 406 bakes the NeRF model onto a mesh for real-time performance, but cannot reproduce the complex fuzzy appearance (31.87 dB PSNR).

FIG. 5 depicts an example 500 of a first rendered object 502 generated using a conventional NeRF rendering technique versus a second rendered object 504 generated using the described per-asset denoising for real-time rendering. The original object is a jungle scene.

In the first example, the scene is rendered using naïve ray marching to generate the first rendered object 502. The first rendered object 502 maintains high visual quality with a PSNR of approximately 21.09 dB. However, for the first rendered object 502, the naïve raymarching approach involves an average of 125 samples per ray.

In the second example, the scene is rendered using the described Monte Carlo importance sampling and per-asset denoising network to generate the second rendered object 504. By utilizing the denoising module 118 and the denoising techniques described herein, the second object 504 is rendered with a PSNR of 20.67 dB, maintaining visual quality comparable to the first rendered object 502, which represents a minimal accuracy loss of 0.42 dB. The described Monte Carlo importance sampling, however, only involves an average of five samples per ray, representing a factor of 25 reduction. This significant reduction in MLP evaluations enables real-time rendering with minimal visual accuracy loss.

### Example Per-Asset Denoising Procedure

The following discussion describes implementable techniques utilizing the previously described systems and devices. Aspects of each procedure are implementable in hardware, firmware, software, or a combination thereof. The procedures are shown as blocks that specify operations performed by one or more devices and are not necessarily limited to the orders shown for performing the operations by the respective blocks. In portions of the following discussion, reference is made to FIGS. 1-5.

FIG. 6 depicts a procedure 600 in an example implementation of per-asset denoising for real-time rendering of NeRFs. To begin, a processing device receives a 3D representation of a scene as a NeRF (block 602). The processing device then generates an intermediate rendering of the scene using the NeRF (block 604). For example, the Monte Carlo sampling module 116 uses Monte Carlo importance sampling to generate the intermediate rendering 210, which includes noise introduced by the importance sampling approach.

A machine-learning model denoises the intermediate rendering to generate a final rendering of the scene (block 606). The machine-learning model is trained on another rendering of the scene. For example, the processing device obtains the other scene rendering in the background using a high-quality, non-real-time rendering scheme. The inputs to the machine-learning model 212 include an RGB image and alpha channel representation (e.g., providing the opacity or transparency of each pixel) of the intermediate rendering 210 and a ground truth image or rendering of the scene. The outputs include features and scalars to generate the final rendering from the intermediate rendering. The intermediate rendering 210 is denoised by computing spatial kernels from the output set of features and scalars and applying the spatial kernels to the intermediate rendering 210 via a convolution operation to generate the final rendering 122.

As described above, the machine-learning model 212 is a convolutional neural network that includes ten or fewer convolutional layers. In one implementation, the machine-learning model 212 includes three convolutional layers with three-by-three kernels and ReLU activations, each convolution layer having eight output channels. The machine-learning model 212 performs image-space denoising to remove noise directly from the pixel values of the intermediate rendering 210 without transforming the pixel values into another domain (e.g., frequency or wavelet).

The processing device then presents the final rendering of the scene on a display device (block 608). By utilizing an efficient sampling approach for the rendering and a lean denoising network, the final rendering is provided in real-time with high-quality visuals.

### Example System and Device

FIG. 7 illustrates an example system 700 that includes an example computing device 702 that is representative of one or more computing systems and/or devices that implement the various techniques described herein. This is illustrated by including the 3D modeling system 104 with the Monte Carlo sampling module 116 and the denoising module 118. The computing device 702 is configurable, for example, as a server of a service provider, a device associated with a client (e.g., a client device), an on-chip system, and/or any other suitable computing device or computing system.

The example computing device 702, as illustrated, includes a processing system 704, one or more computer-readable media 706, and one or more I/O interface 708 that are communicatively coupled to one another. Although not shown, the computing device 702 further includes a system bus or other data and command transfer system that couples the various components from one to another. A system bus includes any one or combination of different bus structures, such as a memory bus or memory controller, a peripheral bus, a universal serial bus, and/or a processor or local bus that utilizes various bus architectures. Various other examples are also contemplated, such as control and data lines.

The processing system 704 is representative of the functionality to perform one or more operations using hardware. Accordingly, the processing system 704 is illustrated as including hardware element 710 that is configurable as processors, functional blocks, and so forth. This includes implementation in hardware as an application-specific integrated circuit or other logic device formed using one or more semiconductors. The hardware elements 710 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically executable instructions.

The computer-readable storage media 706 is illustrated as including memory/storage 712. The memory/storage 712 represents memory/storage capacity associated with one or more computer-readable media. The memory/storage 712 includes volatile media (such as random access memory (RAM)) and/or nonvolatile media (such as read-only memory (ROM), Flash memory, optical disks, magnetic disks, and so forth). The memory/storage 712 includes fixed media (e.g., RAM, ROM, a fixed hard drive, and so on) and removable media (e.g., Flash memory, a removable hard drive, an optical disc, and so forth). The computer-readable media 706 is configurable in various ways, as described below.

Input/output interface(s) 708 are representative of functionality to allow a user to enter commands and information to computing device 702, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 702 is configurable in various ways to support user interaction, as further described below.

Various techniques are described in the general context of software, hardware elements, or program modules. Generally, such modules include routines, programs, objects, elements, components, data structures, and so forth that perform particular tasks or implement abstract data types. The terms “module,” “functionality,” and “component” as used herein generally represent software, firmware, hardware, or a combination thereof. The features of the techniques described herein are platform-independent, meaning that the techniques are configurable on various commercial computing platforms with various processors.

An implementation of the described modules and techniques is stored on or transmitted across some form of computer-readable media. The computer-readable media includes a variety of media that is accessed by the computing device 702. By way of example, and not limitation, computer-readable media includes “computer-readable storage media” and “computer-readable signal media.”

“Computer-readable storage media” refers to media and/or devices that enable persistent and/or non-transitory information storage in contrast to mere signal transmission, carrier waves, or signals per se. Thus, computer-readable storage media refers to non-signal-bearing media. The computer-readable storage media includes hardware such as volatile and non-volatile, removable and non-removable media, and/or storage devices implemented in a method or technology suitable for storage of information such as computer-readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium configured to transmit instructions to the hardware of the computing device 702, such as via a network. Signal media typically embodies computer-readable instructions, data structures, program modules, or other data in a modulated data signal, such as carrier waves, data signals, or another transport mechanism. Signal media also includes any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 710 and computer-readable media 706 are representatives of modules, programmable device logic, and/or fixed device logic implemented in a hardware form that is employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware and hardware utilized to store instructions for execution, e.g., the computer-readable storage media described previously.

Combinations of the foregoing are also employed to implement various techniques described herein. Accordingly, software, hardware, or executable modules are implemented as instructions and/or logic embodied on some form of computer-readable storage media and/or by one or more hardware elements 710. The computing device 702 is configured to implement particular instructions and/or functions corresponding to the software and/or hardware modules. Accordingly, implementation of a module executable by the computing device 702 as software is achieved at least partially in hardware, e.g., through computer-readable storage media and/or hardware elements 710 of the processing system 704. The instructions and/or functions are executable/operable by one or more articles of manufacture (for example, one or more computing devices and/or processing systems 704) to implement techniques, modules, and examples described herein.

The techniques described herein are supported by various configurations of the computing device 702 and are not limited to the specific examples of the techniques described herein. This functionality is also implementable through a distributed system, such as over a “cloud” 714 via a platform 716 as described below.

Cloud 714 includes and/or represents a platform 716 for resources 718. Platform 716 abstracts the underlying functionality of hardware (e.g., servers) and software resources of the cloud 714. Resources 718 include applications and/or data that can be utilized when computer processing is executed on remote servers from the computing device 702. Resources 718 can also include services provided over the Internet and/or through a subscriber network, such as a cellular or Wi-Fi network.

Platform 716 abstracts resources and functions to connect computing device 702 with other computing devices. The platform 716 also serves to abstract scaling of resources to provide a corresponding level of scale to encountered demand for the resources 718 implemented via the platform 716. Accordingly, in an interconnected device embodiment, the implementation of functionality described herein is distributable throughout the system 700. For example, the functionality is implementable in part on the computing device 702 and via the platform 716, which abstracts the functionality of the cloud 714.

What is claimed is:

1. A method comprising:
receiving, by a processing device, a three-dimensional (3D) representation of a scene as a neural radiance field (NeRF);
generating, by the processing device and using the NeRF, a first rendering of the scene;
generating, using a machine-learning model, a second rendering of the scene by denoising the first rendering, the machine-learning model trained on a third rendering of the scene; and
presenting, by the processing device, the second rendering on a display device.

2. The method of claim 1, wherein the machine-learning model is a convolutional neural network with ten or fewer convolutional layers.

3. The method of claim 2, wherein the convolutional neural network includes three convolutional layers with three-by-three kernels and three-by-three rectified linear unit (ReLU) activations.

4. The method of claim 1, wherein the presenting of the second rendering is performed in real-time.

5. The method of claim 1, wherein the machine-learning model performs image-space denoising to remove noise directly from pixel values of the first rendering.

6. The method of claim 1, wherein:
inputs to the machine-learning model include a red-green-blue (RGB) image of the first rendering and an alpha channel representation of the first rendering; and
outputs of the machine-learning model include a set of affinity features and bandwidth scalars to generate the second rendering from the first rendering.

7. The method of claim 6, wherein the method further comprises:
computing, using the set of affinity features and bandwidth scalars, spatial kernels; and
applying the spatial kernels to the first rendering using a convolution operation to generate the second rendering.

8. The method of claim 7, wherein an intensity of the spatial kernels is pooled based on an affinity of a local affinity feature value to a central-pixel affinity feature value.

9. The method of claim 1, wherein training the machine-learning model on the 3D representation comprises:
generating one or more training set frames that include the third rendering as a ground truth image, an RGB image from a noisy rendering of the 3D representation, and an alpha channel of the noisy rendering; and
training the machine-learning model on the training set frames via standard gradient descent to minimize a reconstruction loss and a structure-preserving loss.

10. The method of claim 9, wherein the third rendering is generated from the NeRF representation using a non-real-time rendering scheme.

11. A system comprising:
a memory component; and
one or more processing devices coupled to the memory component, the one or more processing devices to perform operations comprising:
receive a three-dimensional (3D) representation of a scene as a neural radiance field (NeRF);
generate, using a Monte Carlo sampling algorithm, a first rendering of the scene in real-time;
generate, using a machine-learning model, a second rendering of the scene by denoising the first rendering, the machine-learning model trained on a non-real-time rendering of the scene; and
present the second rendering on a display device in real-time.

12. The system of claim 11, wherein the machine-learning model is a convolutional neural network with ten or fewer convolutional layers.

13. The system of claim 12, wherein the convolutional neural network includes three convolutional layers with three-by-three kernels and three-by-three rectified linear unit (ReLU) activations.

14. The system of claim 11, wherein the machine-learning model performs image-space denoising to remove noise directly from pixel values of the first rendering.

15. The system of claim 11, wherein:
inputs to the machine-learning model include a red-green-blue (RGB) image of the first rendering and an alpha channel representation of the first rendering; and
outputs of the machine-learning model include a set of affinity features and bandwidth scalars to generate the second rendering from the first rendering.

16. The system of claim 15, wherein the one or more processing devices perform additional operations comprising:
compute, using the set of affinity features and bandwidth scalars, spatial kernels; and
apply the spatial kernels to the first rendering using a convolution operation to generate the second rendering.

17. The system of claim 16, wherein an intensity of the spatial kernels is pooled based on an affinity of a local affinity feature value to a central-pixel affinity feature value.

18. The system of claim 11, wherein the one or more processing device perform additional operations comprising train the machine-learning model on the 3D representation by:
generating one or more training set frames that include the non-real-time rendering as a ground truth image, an RGB image from a noisy rendering of the 3D representation, and an alpha channel of the noisy rendering; and
training the machine-learning model on the training set frames via standard gradient descent to minimize a reconstruction loss and a structure-preserving loss.

19. A non-transitory computer-readable storage medium storing executable instructions, which when executed by a processing device, cause the processing device to perform operations comprising:
receiving a three-dimensional (3D) representation of a scene as a neural radiance field (NeRF);
generating, using the NeRF, a first rendering of the scene;
generating, using a machine-learning model, a second rendering of the scene by denoising the first rendering, the machine-learning model trained on a non-real-time rendering of the scene; and
presenting the second rendering on a display device.

20. The non-transitory computer-readable storage medium of claim 19, wherein the machine-learning model is a convolutional neural network that includes three convolutional layers with three-by-three kernels and three-by-three rectified linear unit (ReLU) activations.
